(19) United States
(12) Patent Application Publication
(10) Pub. No.: US 2006/0015698 A1
(43) Pub. Date: Jan. 19, 2006

(54) Method and apparatus for data backup

(75) Inventors: Jin-min Kim, Seoul (KR); Han-sub Park, Anyang-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/226,204

(22) Filed: Sep. 15, 2005

(30) Foreign Application Priority Data
May 11, 2004 (KR) 10-2004-0089699

(51) Int. Cl. G06F 12/16

(52) U.S. Cl. 711/162

(57) ABSTRACT

A data backup method and a data backup apparatus in which a part of a user data area in a volatile memory, wherein data is lost when the power is turned off, is predesignated as a backup area and data is rapidly backed up in an emergency. The data backup method includes the operations of: receiving a command related to data backup through a user interface; obtaining a backup area which is a continuous space of a desired size by adjusting backup priorities between pieces of backup object data when the backup area is to be adjusted in order to execute the command; moving and storing data of the obtained backup area to a non-volatile memory according to a predetermined condition. Accordingly, the user data backup can be rapidly and automatically executed to prevent permanent loss of a database, document file, and the like.

### CROSS-REFERENCE TO RELATED APPLICATION

This application claims the priority of Korean Patent Application No. 2004-0089699, filed on Nov. 5, 2004, in the Korean Intellectual Property Office, the disclosure of which is incorporated herein by reference.

### BACKGROUND OF THE INVENTION

1. Field of the Invention

The present invention relates to data backup, and more particularly, to a method and apparatus for rapidly backing up data in an emergency by predesignating a part of a user data area of a volatile memory in which data is lost when the power is turned off as a backup area.

2. Description of Related Art

A mobile terminal device such as a personal digital assistant (PDA) and a pocket PC (personal computer) includes a ROM (read only memory), which is a non-volatile memory, and a RAM (random access memory), which is a volatile memory. Since data stored in the ROM is not erased even when the power is turned off, operating system (OS) data of the mobile terminal device is stored in the ROM. Further, many types of data, which are generated, stored, and deleted while the operating system is running on and application programs are executed in the OS, are stored in the RAM. Therefore, the RAM stores not only data generated while an OS runs but also data, document files, registries and the like which are generated by application programs or created by a user.

However, since the RAM is a volatile memory, all data recorded in the RAM is lost when power is turned off. Thus, when a battery of a mobile terminal device is discharged, data stored in the RAM should be rapidly backed up to a ROM or other non-volatile memory before the battery power is exhausted in order to avoid loss of data stored in the RAM.

Conventionally, all data stored in the RAM is backed up by scanning the entire RAM through an API (application program interface) provided by an OS. As a result, it takes much time to back up data.

### BRIEF SUMMARY

An aspect of the present invention provides a method and apparatus for data backup, by which a predetermined area of a RAM (random access memory) is predesignated as a backup area, a list of data to be written in the backup area is managed and the data in the backup area is rapidly backed up to a non-volatile memory when a battery power goes below a predetermined level.

According to an aspect of the present invention, there is provided a data backup method comprising the operations of: receiving a command related to data backup through a user interface; obtaining a backup area which is a continuous space of a desired size by adjusting backup priorities between pieces of backup object data when the backup area is to be adjusted in order to execute the command; moving and storing data of the obtained backup area to a non-volatile memory according to a predetermined condition.

When the received command is a backup area setting command, the operation of obtaining the backup area may obtain an area to be backed up which has a continuous space as large as the size of the backup area of the received command by determining whether a currently executed process is terminated and terminating the process according to the determining result.

The operation of obtaining the backup area may add additional backup object data to a list of objects to be backed up after determining whether a backup area of continuous space can be obtained and expanding a backup area according to the determining result when the received command is a backup object adding command.

The operation of obtaining the backup area may expand an area to be backed up by terminating a currently executed process or moves and stores backup object data with lower priority among pieces of backup object data included in the backup object list to a general area when available capability of a memory is insufficient due to adding a backup object.

According to another aspect of the present invention, there is provided a computer readable recording medium whereon a backup data structure is recorded, the computer readable recording medium comprising: a general area in which data, which will be immediately deleted when power is not supplied, is stored; and a backup area in which data, which will be moved and stored to a non-volatile memory if a predetermined condition is met, is stored, wherein according to a backup data management command received through a user interface, the data written in the backup area is moved and stored to the general area or the data written in the general area is moved and stored to the backup area according to backup priorities of data.

According to still another aspect of the present invention, there is provided a data backup apparatus comprising: a user interface unit receiving a backup data management command; a determining unit determining whether a backup area is adjusted to execute the command and obtaining a continuous backup area of desired size by adjusting backup priorities between pieces of backup object data according to the determining result; and a backup executing unit moving and storing data of the obtained backup area to a non-volatile memory according to a predetermined condition.

When the received command is a backup area setting command, the determining unit may issue a command to obtain an area to be backed up which has a continuous space as large as the size of the backup area of the received command by determining whether it is needed to terminated a currently executed process and terminating the process according to the determining result.

According to another aspect of the present invention, there is provided a method of setting a backup area, including: receiving data about the size of an area to be backed up; adjusting a size of the area to be backed up based on an available capability of a RAM; and setting a continuous area as the area to be backed up.

According to another aspect of the present invention, there is provided a method of expanding the backup area, including: determining whether a size of an area to be expanded is not greater than an available capability of a RAM; determining whether a continuous area of the RAM can be obtained by terminating a currently executed process, when the size of the area to be expanded is not greater that the size of the available capability of the RAM; terminating the currently executed process and adding an original area of the backup area and an additional area to adjust the backup area and the size thereof, when the process is determined to be terminated; performing a soft reset after the terminating; adding the original area of the backup area and the additional area to adjust the backup area and the size thereof, when the currently executed process is determined not to be terminated; determining whether the additional area can be obtained when backup object data having lower priority than the backup object data which is to be added is deleted from the backup object list, when the size of the area to be expanded is greater than the available capability of the RAM; setting the size of the area to be backed up to a maximum available capability limit of the RAM; and adjusting the backup priorities.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a diagram of memories included in a mobile terminal device, according to an embodiment of the present invention;

FIG. 2 is a flowchart showing a backup area setting method according to an embodiment of the present invention;

FIG. 3 is a flowchart showing in detail operation S230 of FIG. 2;

FIG. 4 is a flowchart showing a method of adding a backup object to a backup object list;

FIG. 5 is a flowchart showing a method of expanding the backup area;

FIG. 6 is a flowchart showing a method of deleting a backup object from a backup object list;

FIG. 7 is a flowchart showing a method of managing a backup object list and processing a backup object; and

FIG. 8 is a block diagram of a user data backup apparatus according to an embodiment of the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures

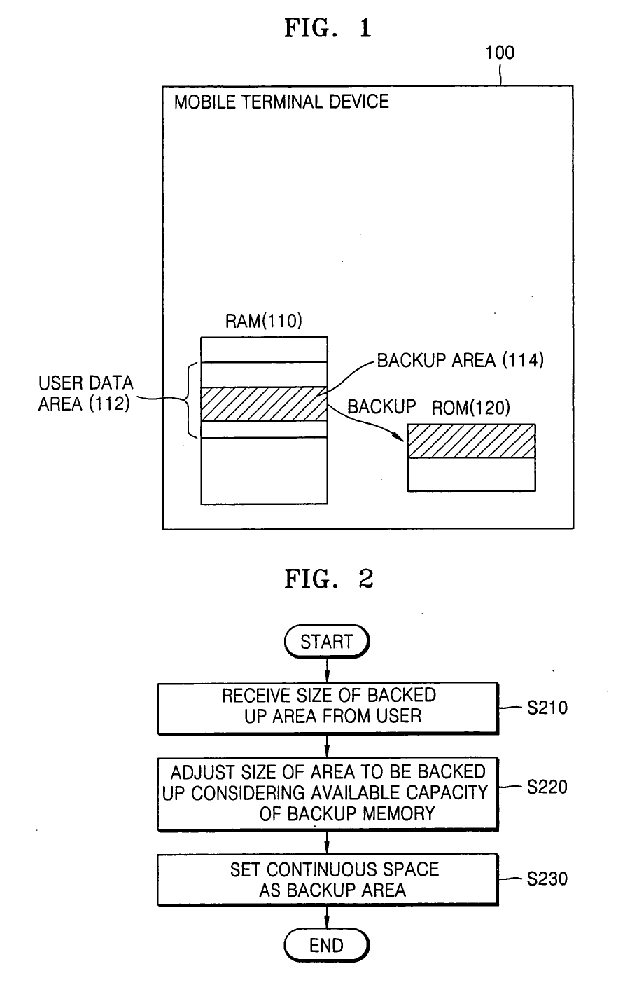

FIG. 1 is a diagram of memories included in a mobile terminal device 100, according to an embodiment of the present invention.

Referring to FIG. 1, the mobile terminal device 100 includes a RAM (random access memory) 110, which is a volatile memory, and a ROM (read only memory) 120, which is a non-volatile memory. A predetermined area of the RAM 110 is designated as a user data area 112, in which user data generated using an application program are stored. Further, a part of the user data area 112 is set as a backup area 114, in which data required to be backed up among the user data are stored. Thus, the when power of the mobile terminal device 100 is turned off, only the data stored in the backup area 114 is backed up to the ROM 120.

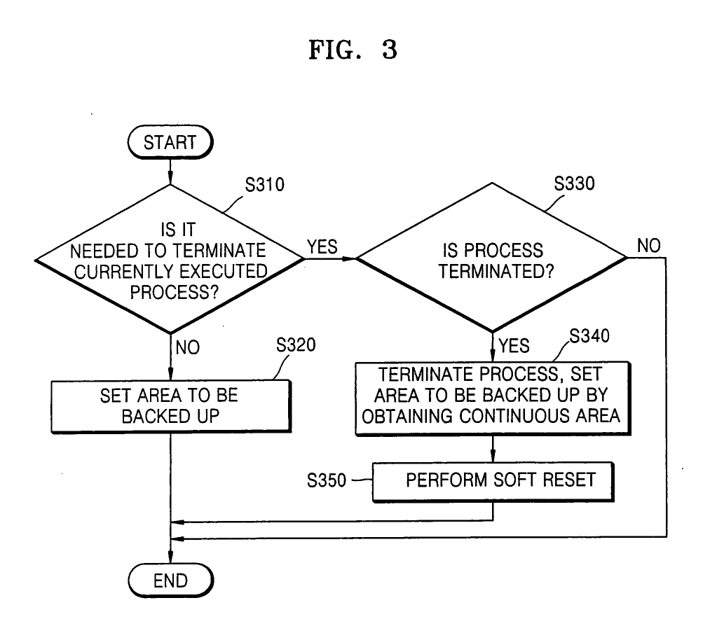

FIG. 2 is a flowchart showing a backup area setting method according to an embodiment of the present invention.

Data about the size of an area to be backed up is input by a user (operation S210). That is, data about how large size of the RAM area is backed up is input through a user interface. In other words, a menu is provided to the user through an application program or the like, and size data is input by receiving a user input. Next, the size of the area to be backed up is adjusted in consideration of the available capability of the RAM (operation S220). That is, if the RAM size is 64 Mbytes and excluding an area that is to be used by an operating system and other required programs, the size of an area that the user can use in the RAM is limited to 30 Mbytes, and when the user sets an area above 30 Mbytes to be backed up, the size of the area to be backed up is adjusted to 30 Mbytes which is the limit size of the available area. Then, a continuous area is obtained and set as the area to be backed up (operation S230). To speed up the backup process, the area of 30 Mbytes is obtained as a continuous space of the RAM.

FIG. 3 is a flowchart showing in detail the operation S230 of FIG. 2.

To obtain a continuous space of the RAM as a backup area, it is checked that an area used by a current process or program being executed is needed (operation S310). When the area is not needed, the backup area of the RAM is set such that data space as large as the size of the area to be backed up which is adjusted in the operation S220 becomes a continuous area (S320). Since an application program or a process may use some areas of the RAM, in the operation 310, it is determined that the application program or process is terminated to obtain the continuous backup space set by the user.

As the determining result of the operation S310, if the area used by the current process or the application program being executed is needed, the user is asked whether to obtain a continuous area even by terminating the process or the application program (operation S330). Then, when the process or the application program is not terminated, the operation is ended without setting backup area. When the user intends to obtain the continuous area by terminating the process or the application program, the process or the application program is terminated and a continuous backup area is set (operation S340.) After setting the backup area, a soft reset is performed (operation S350). The soft reset, which is for initializing or restoring a variable or a memory used when the process or the application program is executed, is not necessarily performed.

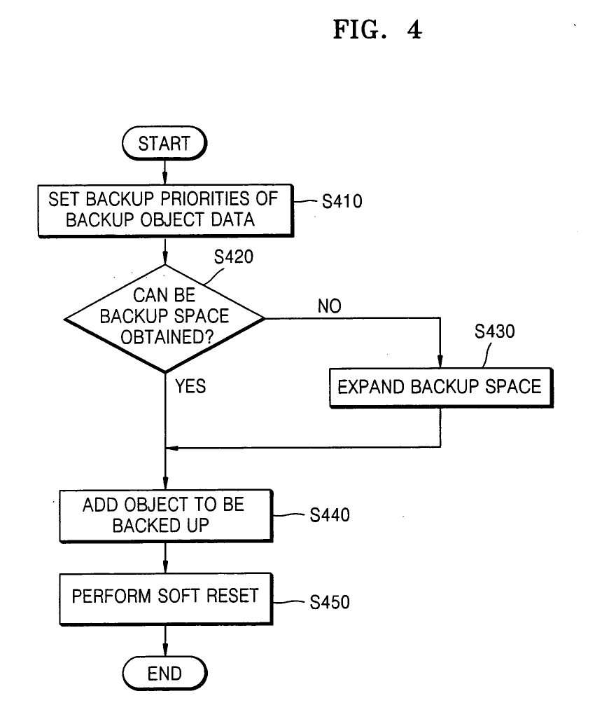

FIG. 4 is a flowchart showing a method of adding a backup object to a backup object list.

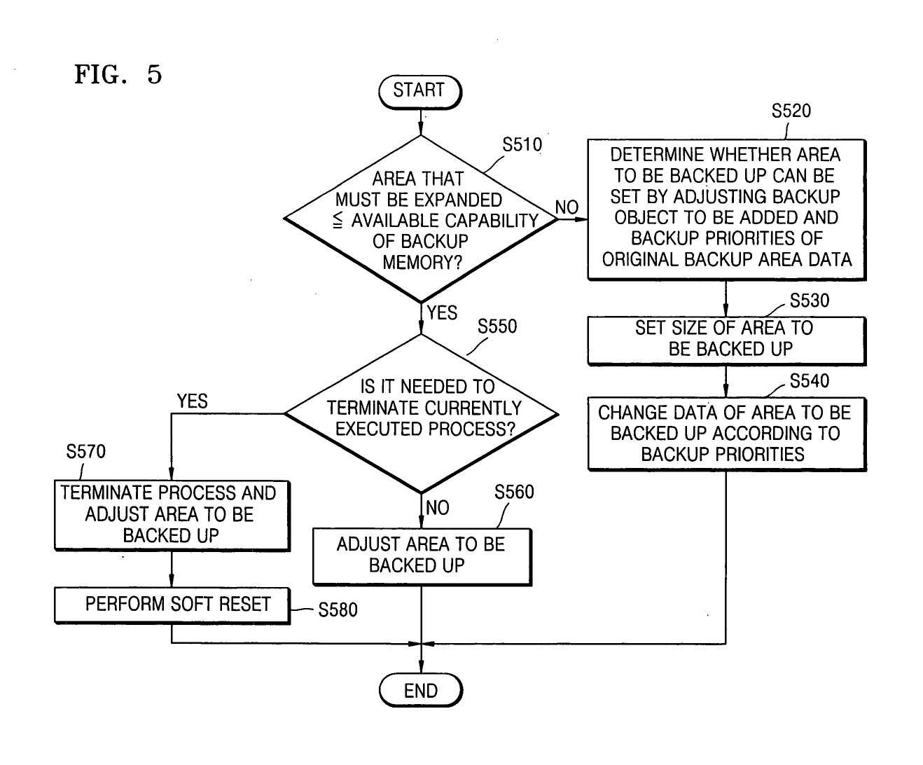

Backup priorities of backup object data intended to be added to a backup object list are set and registered (operation S410). Then, it is determined whether a backup space to which the backup object data that the user intends to add can be obtained (operation S420). That is, comparing among the backup area the size A of the space available for the user with the size B of the backup object data, when A is not less than B, it is determined that the backup space can be obtained and the backup object data is recorded in the backup area and added to a backup object list (operation S440). Further, if necessary, the soft reset is performed (operation S450). Describing more specifically the operation S440 in which the backup object data is recorded in the backup area and added to the backup object list, the backup object data is moved from a general area to the backup area and added to the backup object list. A general area of a RAM is not backed up, and a backup area is backed up immediately before power is turned off. Meanwhile, as the determining result of the operation S420, when the backup area cannot be obtained, it is determined whether the backup space can be expanded and, if possible, the backup space is expanded (operation S430). Expanding of the backup space will be described in detail with reference to FIG. 5.

FIG. 5 is a flowchart showing a method of expanding the backup area.

It is determined whether the size of an area to be expanded is not greater than the available capability of the RAM (operation S510). When the size of the area to be expanded is not greater that the size of the available capability of the RAM, it is determined whether the continuous area of the RAM can be obtained by terminating the currently executed process (operation S550). When the process is determined to be terminated, the process is terminated and an original area of the backup area and an additional area are added to adjust the backup area and the size thereof (operation S570). After the operation S570, the soft reset is performed (operation S580). When the currently executed process is determined not to be terminated, the original area of the backup area and the additional area are added to adjust the backup area and the size thereof (operation S560).

When the size of the area to be expanded is greater than the available capability of the RAM, it is determined whether the additional area can be obtained if backup object data having lower priority than the backup object data which is to be added is deleted from the backup object list (operation S520). Then, the size of the area to be backed up is set to the maximum available capability limit of the RAM (operation S530), and the backup priorities are adjusted (operation S540). Specifically, the backup object data with lower priority is moved from the backup area to general area of the RAM.

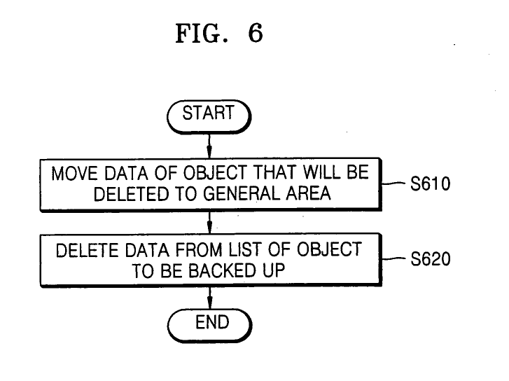

FIG. 6 is a flowchart showing a method of deleting a backup object from a backup object list.

Data of an object to be deleted is moved from the backup area and stored to the general area (operation S610), and deleted from the backup object list (operation S620).

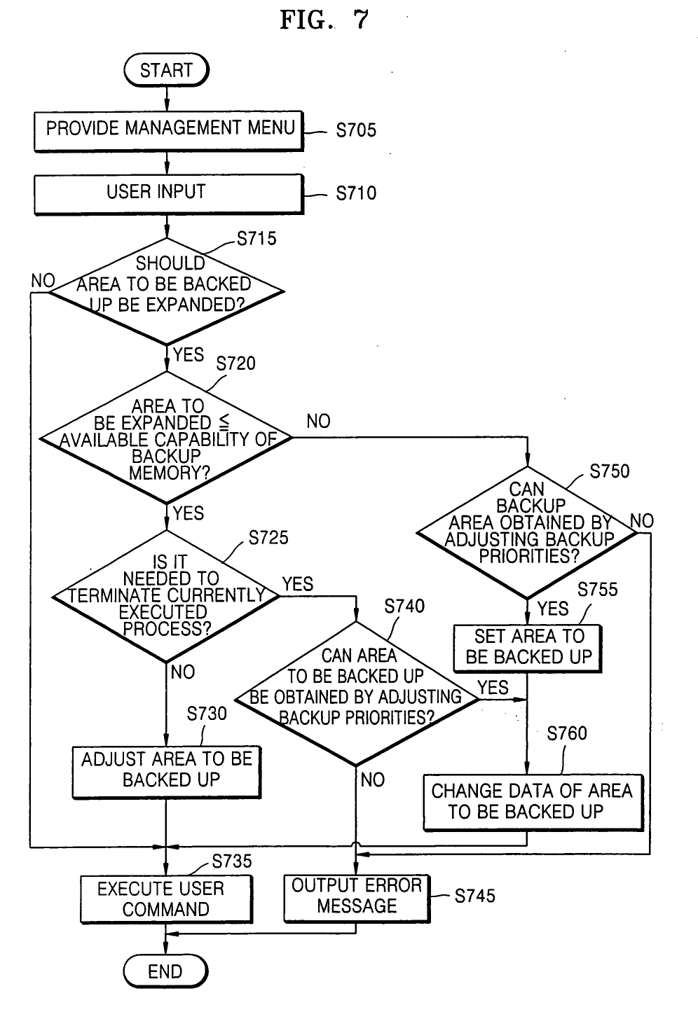

FIG. 7 is a flowchart showing a method of managing the backup object list and processing the backup object.

A backup area management menu is provided through a user interface (operation S705). A user inputs a command such as backup area setting, backup object adding or backup object deleting by using the backup area management menu (operation S710). It is determined whether the size of the backup area is expanded to execute the user's command (operation S715). Then, if the size of the backup area is to be expanded, it is determined whether the size of the area to be expanded is greater than the available capability of the RAM (operation S720). When the size of the area to be expanded is not greater than the available capability of the RAM, it is determined whether the backup area is intended to be obtained by terminating the currently executed process (operation S725). When it is not necessary to terminate the currently executed process, the area to be backed up is adjusted (operation S730), and the input user command is performed (operation S735). As the determining result of the operation S725, when it is necessary to terminate the process, it is determined whether the area to be backed up is intended to be obtained by adjusting the backup priorities of the backup object data (operation S740). When it is not intended to adjust the backup priorities, an error message is output (operation S745) and the operation is ended. When it is intended to adjust the backup priorities, the data with lower priority is moved from the backup area to the general area (operation S760).

Meanwhile, in the operation S720, when the size of the area to be expanded is greater than the available capability of the RAM, it is determined whether the backup area is intended to be obtained by adjusting the backup priorities of the backup object data (operation S750). When it is not intended to adjust the backup priorities, an error message is output (operation S745) and the operation is ended. When it is intended to adjust the backup priorities, the area to be backed up is set to the maximum available capability limit of the RAM (operation S755), and data with lower priority in the area to be backed up is moved from the backup area and stored to the general area (operation S760).

Further, in the operation S715, when it is not necessary to extend the size of the area to be backed up so as to perform the user's command, the input user command is performed (operation S735) and the operation is ended.

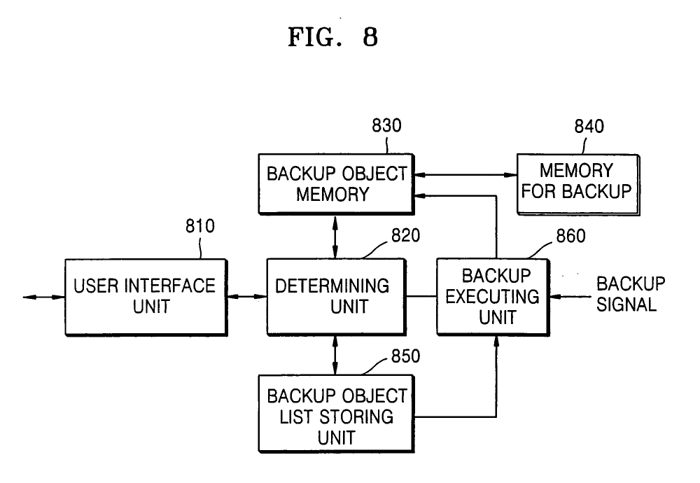

FIG. 8 is a block diagram of a user data backup apparatus.

The user data backup apparatus includes a user interface unit 810, a determining unit 820, a backup object list storing unit 850, and a backup executing unit 860. Also, the user data backup apparatus includes a backup object memory 830 and a memory 840 for backup. The backup object memory 830 may be a volatile memory such as a RAM or the like, and the memory 840 for backup may be a non-volatile memory such as a ROM or a flash memory.

The user interface unit 810 provides a menu related to data backup to a user, and receives a backup related command such as backup area setting, adding, deleting, etc. from the user. The determining unit 820 determines a backup area is needed to be changed in order to perform the received backup related command and, according to the determining result, makes the backup area, backup priorities of the backup object data, a backup object list and the like. Also, the determining unit 820 manages the backup area and a general area of the backup object memory 830, and issues a command for moving data between the two areas. The backup object list storing unit 850 stores the backup object list. The backup executing unit 860 senses a backup signal which is a signal of an emergency such as power down below a certain level and executes backup. That is, the backup executing unit 860 stores the backup area of the backup object memory 830 to the memory 840 for backup.

The above-described data backup method can be written as a computer program and stored on a computer-readable storage medium. Further, the data backup method can be implemented in a computer which reads and executes the program. Examples of the computer-readable storage media include magnetic storage media, optical recording media, and storage media such as carrier waves.

According to the above-described embodiments of the present invention, user data backup is automatically and rapidly executed, the user data backup for avoiding permanent loss of a database, document file and the like which are stored in a RAM when power of a mobile device using the RAM as working space is discharged.

That is, a predetermined area of the RAM is obtained in advance as a backup area in which objects that must be backed up are registered. Also, data that must be backed up is stored in the backup area, and copied to a memory for backup in an emergency, and therefore loss of data can be prevented.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A data backup method comprising:
receiving a command related to data backup through a user interface;
obtaining a backup area which is a continuous space of a desired size by adjusting backup priorities between pieces of backup object data when the backup area is to be adjusted in order to execute the command;
moving and storing data of the obtained backup area to a non-volatile memory according to a predetermined condition.

2. The data backup method of claim 1, wherein, when the command is a backup area setting command, the obtaining a backup area comprises obtaining an area to be backed up which has a continuous space as large as the size of the backup area of the command by determining whether a currently executed process is terminated and terminating the process according to the determining result.

3. The data backup method of claim 1, wherein the obtaining a backup area comprises adding additional backup object data to a list of objects to be backed up after determining whether a backup area of continuous space can be obtained and expanding a backup area according to the determining result when the command is a backup object adding command.

4. The data backup method of claim 3, wherein the obtaining a backup area comprises expanding an area to be backed up by terminating a currently executed process or moving and storing backup object data with lower priority among pieces of backup object data included in the backup object list to a general area when available capability of a memory is insufficient due to adding a backup object.

5. The data backup method of claim 1, wherein the obtaining a backup area comprises moving and storing object data to be deleted from a backup area to a general area and deleting the object data from a backup object list when the received command is a backup data deleting command.

6. The data backup method of claim 1, wherein the moving and storing data includes moving and storing the data of the obtained backup area to a non-volatile memory when power supplied to a memory having the backup area falls below a predetermined level.

7. A computer-readable storage medium having a backup data structure recorded thereon, the medium comprising:
a general area in which data, which will be immediately deleted when power is not supplied, is stored; and
a backup area in which data, which will be moved and stored to a non-volatile memory when a predetermined condition is met, is stored,
wherein according to a backup data management command received through a user interface, the data written in the backup area is moved and stored to the general area or the data written in the general area is moved and stored to the backup area according to backup priorities of data.

8. A data backup apparatus comprising:
a user interface unit receiving a backup data management command;
a determining unit determining whether a backup area is adjusted to execute the command and obtaining a continuous backup area of desired size by adjusting backup priorities between pieces of backup object data according to the determining result; and
a backup executing unit moving and storing data of the obtained backup area to a non-volatile memory according to a predetermined condition.

9. The data backup apparatus of claim 8, further comprising a backup object list storing unit storing the backup object data in a list form.

10. The data backup apparatus of claim 8, wherein, when the command is a backup area setting command, the determining unit issues a command to obtain an area to be backed up which has a continuous space as large as the size of the backup area of the command by determining whether it is needed to terminated a currently executed process and terminating the process according to the determining result.

11. The data backup apparatus of claim 8, wherein the determining unit issues a command to add an additional backup object data to a list of a object to be backed up after determining whether a backup area of continuous space and expanding the backup area according to the determining result when the command is a backup object adding command.

12. The data backup apparatus of claim 11, wherein the determining unit issues a command to expand an area to be backed up by terminating a currently executed process or move and store backup object data with lower priority among pieces of the backup object data in the backup object list to a general area when a backup object is added and therefore available capability is lacking.

13. The data backup apparatus of claim 8, wherein the determining unit moves object data to be deleted from a backup area and stores the object data to a general area, and deletes the object data from the backup object list when the command is a backup data deleting command.

14. The data backup apparatus of claim 8, wherein the backup executing unit moves and stores the data of the obtained backup area to a non-volatile memory when power supplied to a memory having the backup area falls below a predetermined level.

15. A computer-readable storage medium encoded with processing instructions for causing a processor to perform a data backup method, the method comprising:
receiving a command related to data backup through a user interface;
obtaining a backup area which is a continuous space of a desired size by adjusting backup priorities between pieces of backup object data when the backup area is to be adjusted in order to execute the command;
moving and storing data of the obtained backup area to a non-volatile memory according to a predetermined condition.

16. A method of setting a backup area, comprising:
receiving data about the size of an area to be backed up;
adjusting a size of the area to be backed up based on an available capability of a RAM; and
setting a continuous area as the area to be backed up.

17. The method of claim 16, wherein the setting comprises:
checking whether an area used by a current process or program being executed is needed;
setting the backup area of the RAM such that data space as large as the adjusted size of the area to be backed up is a continuous area, when the area used by the current process or program is not needed;
determining whether to obtain a continuous area even by terminating the process or the application program, when the area used by the current process or the application program being executed is needed; and
terminating the process or the application program and setting a continuous backup area, when the continuous area is to be obtained by terminating the process or the application program.

18. The method of claim 17, wherein the setting further comprises performing a soft reset after the terminating.

19. A method of expanding the backup area, comprising:
determining whether a size of an area to be expanded is not greater than an available capability of a RAM;
determining whether a continuous area of the RAM can be obtained by terminating a currently executed process, when the size of the area to be expanded is not greater that the size of the available capability of the RAM;
terminating the currently executed process and adding an original area of the backup area and an additional area to adjust the backup area and the size thereof, when the process is determined to be terminated;
performing a soft reset after the terminating;
adding the original area of the backup area and the additional area to adjust the backup area and the size thereof, when the currently executed process is determined not to be terminated;
determining whether the additional area can be obtained when backup object data having lower priority than the backup object data which is to be added is deleted from the backup object list, when the size of the area to be expanded is greater than the available capability of the RAM;
setting the size of the area to be backed up to a maximum available capability limit of the RAM; and
adjusting the backup priorities.
